(19) United States
(12) Patent Application Publication
(10) Pub. No.: US 2003/0098782 A1
(43) Pub. Date: May 29, 2003

(54) Method and apparatus for dynamic group addressing

(76) Inventors: Neil S. Eastman, Boynton Beach, FL (US); Mark Rindsberg, Boca Raton, FL (US)

Correspondence Address: Pablo Meles, Esq., Akerman, Senterfitt & Eidson, P.A., Post Office Box 3188, West Palm Beach, FL, 33402-3188, US

(21) Appl. No.: 09/994,550

(22) Filed: Nov. 27, 2001

(51) Int. Cl. H04Q 7/14

(52) U.S. Cl. 340/7.46; 340/438

(57) ABSTRACT

A method (600) of dynamic group addressing in a digital audio receiver unit (28) includes the steps of receiving (602) a plurality of messages broadcast to a digital audio receiver among a plurality of digital audio receivers and receiving (604) at least one environmental input at the digital audio receiver. The method further includes the step (608 and 612) of selectively decoding at least one of the plurality of messages broadcast based on a selective call address and at least one environmental input received at the digital audio receiver.

### CROSS-REFERENCE TO RELATED APPLICATIONS

(not applicable)

### FIELD OF THE INVENTION

The invention relates generally to a method and apparatus for selective addressing, and more particularly to a method and apparatus for selectively addressing in a dynamic fashion using environmental data.

### BACKGROUND OF THE INVENTION

A paging system or selective call system provides transmission of selective call messages from a message originator to a selective call receiver. The originator contacts a selective call terminal either through a telephone network or the internet for example and provides the content of the message and information identifying the intended receiver to the terminal. The selective call terminal encodes the message into one of several known protocols, such as the POCSAG or FLEX signaling code. In addition, the terminal appends an address assigned to the selective call receiver to the message. The address and message are then modulated onto a selective call signal and transmitted from the selective call terminal. When the selective call receiver recognizes its address within the selective call signal, the message is then demodulated and decoded.

It is more economical for a selective call system service provider to have denser selective call traffic (i.e., a greater number of messages transmitted per hour). Therefore, if a single message is to be transmitted to a number of selective call receivers, the option of group calling is appealing to the service provider. There are two types of group calling: radio group calling and terminal group calling. Radio group calling requires an additional group address to be permanently assigned to receivers within a group. Radio group calling provides the greatest savings in air time in that a single address and message can be provided to multiple receivers within a group. Yet, radio group calling is inflexible. To change the receivers assigned to the group, the receivers would need to be reprogrammed to remove or add the group address.

Terminal group calling is more dynamic in that the members of the group can be defined at the terminal as a message is prepared for transmission. One example of terminal group calling is the multiple addressing of voice messages in the Golay Sequencing Code signaling protocol. Yet, terminal group calling does not result in substantial air time savings for the service provider. At a minimum, multiple addresses need to be transmitted from the terminal and, in some terminal group calling schemes, the message also needs to be sent a number of times. Even though terminal group calling is more dynamic that radio group call, it is still somewhat static in the sense that user intervention is still required. In other words, a user can subscribe to a particular information feed by calling or contacting a paging carrier. The carrier then sends a message over the air to the pager to set a group address to allow the pager or selective call receiver to receive the information. A receiver that subscribes to certain information based on certain environmental conditions will not be able to filter out irrelevant or non-useful information based on the set group address or terminal address. For example, satellite digital radio will soon become common in automobiles, other vehicles, as well as homes and offices, and stale messages could be sent to users that could be filtered automatically with some forethought.

Satellite radio operators will soon provide digital radio broadcast services covering the entire continental United States. These services will offer approximately 100 channels, of which nearly 50 channels in a typical configuration will provide music with the remaining stations offering news, sports, talk and data channels. Digital radio may also be available in the near future from conventional analog radio broadcasters that will provide a terrestrial based system using signals co-located in the AM and FM bands.

Satellite radio has the ability to improve terrestrial radio's potential by offering a better audio quality, greater coverage and fewer commercials. Accordingly, in October of 1997, the Federal Communications Commission (FCC) granted two national satellite radio broadcast licenses. The FCC allocated 25 megahertz (MHZ) of the electromagnetic spectrum for satellite digital broadcasting, 12.5 MHz of which are owned by “XM Satellite Radio Inc.”, the assignee of the present application and another 12.5 MHz of which are owned by a second company.

The system plan for each licensee presently includes transmission of substantially the same program content from two or more geosynchronous or geostationary satellites to both mobile and fixed receivers on the ground. In urban canyons and other high population density areas with limited line-of-sight (LOS) satellite coverage, terrestrial repeaters will broadcast the same program content in order to improve coverage reliability. Some mobile receivers will be capable of simultaneously receiving signals from two satellites and one terrestrial repeater for combined spatial, frequency and time diversity, which provides significant mitigation of multi-path interference and addresses reception issues associated with blockage of the satellite signals.

In accordance with XM Satellite Radio's unique scheme, the 12.5 MHZ band will be split into 6 slots. Four slots will be used for satellite transmission. The remaining two slots will be used for terrestrial reinforcement.

In accordance with the XM frequency plan, each of two geostationary satellites will transmit identical or at least similar program content. The signals transmitted with QPSK modulation from each satellite (hereinafter satellite 1 and satellite 2). For reliable reception, the LOS signals transmitted from satellite 1 are received, reformatted to Multi-Carrier Modulation (MCM) and rebroadcast by terrestrial repeaters. The assigned 12.5 MHZ bandwidth (hereinafter the “XM” band) is partitioned into two equal ensembles or program groups A and B. Each ensemble will be transmitted by each satellite on a separate radio frequency (RF) carrier. Each RF carrier supports up to 50 channels of music or data in Time Division Multiplex (TDM) format.

Thus, in a digital audio radio system such as the system described above, a need exists for a method and a device that allows for tailored or dynamic addressing based on user needs, habits or preferences that may vary over time or over different environmental conditions.

### SUMMARY OF THE INVENTION

In a first aspect of the present invention, a method of dynamic group addressing in a digital audio receiver unit, comprises the steps of receiving a plurality of messages broadcast to a digital audio receiver, receiving at least one environmental input at the digital audio receiver, and selectively decoding at least one of the messages broadcast based on a selective call address and at least one environmental input received at the digital audio receiver.

In a second aspect of the present invention, a digital receiver unit having dynamic group addressing comprises a digital audio receiver for receiving a plurality of messages that can be targeted, a plurality of environmental inputs used for targeting at least one of the plurality of messages, and a processor. The processor is preferably programmed to receive at least one of the plurality of environmental inputs and dynamically address the plurality of messages based on the data obtained from at least one of the plurality of environmental inputs.

In a third aspect of the present invention, a digital receiver unit that can be dynamically addressed comprises a receiver capable of receiving a plurality of content specific messages and a processor for receiving at least one environmental input used to dynamically address the receiver, wherein the processor is programmed to selectively decode messages matching a condition set by the at least one input.

In a fourth aspect of the present invention, a satellite digital radio capable of being addressed with selective call messages comprises a selective call receiver for receiving a plurality of messages targeted for a group of users meeting a specified criteria, a plurality of inputs coupled to a user interface for the satellite digital radio for providing at least a portion of the specified criteria and a decoder for decoding at least a portion of the plurality of messages matching a group call address and meeting the specified criteria.

### BRIEF DESCRIPTION OF THE DRAWINGS

FIG. 1 illustrates a Satellite digital audio radio service system architecture in accordance with the present invention.

FIG. 2 is a block diagram illustrating a digital audio radio in a mobile or telematics setting in accordance with the present invention.

FIG. 3 is a diagram illustrating a representative bit stream in a frame format for distributing data in accordance with the present invention.

FIG. 4 is a block diagram illustrating a digital audio radio system in accordance with the present invention.

FIG. 5 is a flowchart illustrating a method in accordance with the present invention.

FIG. 6 is a flowchart illustrating another method in accordance with the present invention.

FIG. 7 is a sample group address table representation that could be used by a transmitter in accordance with the present invention.

FIG. 8 is a sample group address table representation that could be used by a receiver in accordance with the present invention.

FIG. 9 is another flow chart illustrating another alternative method in accordance with the present invention.

FIG. 10 is a block diagram illustrating the interaction between a processor, group address tables, and environmental inputs in accordance with the present invention.

### DETAILED DESCRIPTION OF THE DRAWINGS

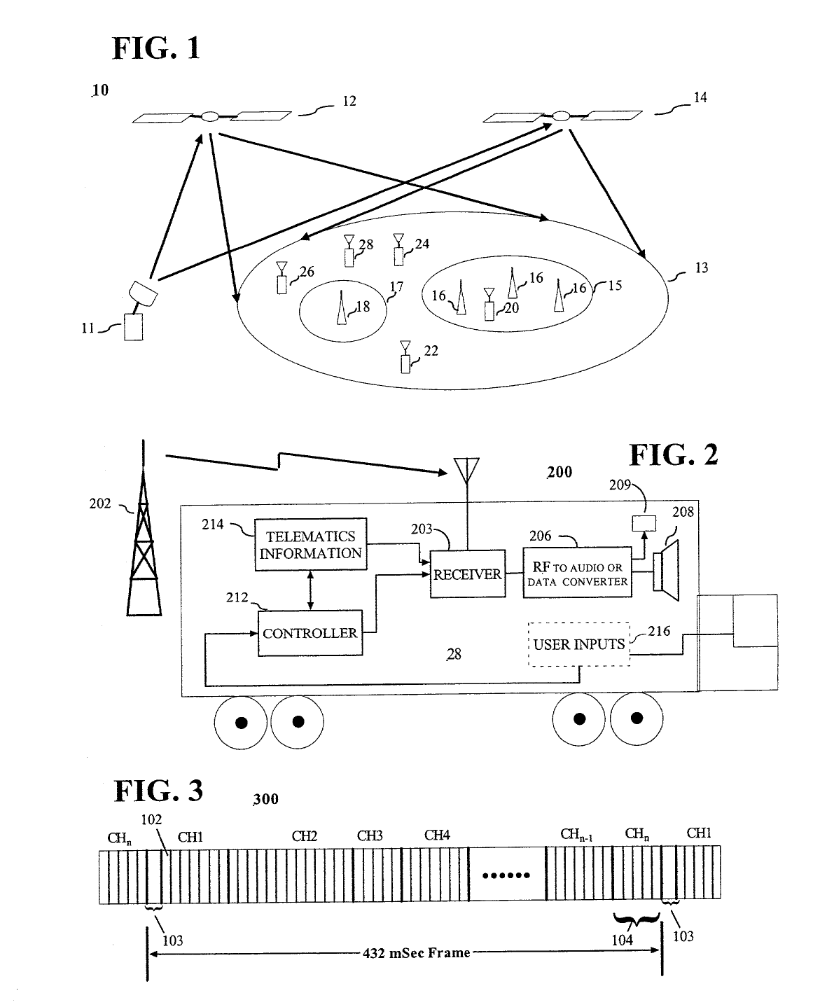

Referring to FIG. 1, satellite radio operators will soon provide digital radio service to the continental United States. Briefly, the service provided by XM Satellite Radio includes a satellite X-band uplink (11) to two satellites (12 and 14) which provide frequency translation to the S-band for re-transmission to radio receivers (28, 20, 22, 24, and 26) on earth within the coverage area (13). Radio frequency carriers from one of the satellites are also received by terrestrial repeaters (16 and 18). The content received at the repeaters is retransmitted at a different S-band carrier to the same radios (20) that are within their respective coverage areas (15 and 17). These terrestrial repeaters facilitate reliable reception in geographic areas where LOS reception from the satellites is obscured by tall buildings, hills, tunnels and other obstructions. The SDARS receivers (20-28) receive the signals transmitted by the satellites (12 and 14) and the repeaters 16 and 18. As depicted in FIG. 1, the receivers may be located in automobiles, handheld or stationary units for home or office use. The SDARS receivers are designed to receive one or both of the satellite signals and the signals from the terrestrial repeaters and combine or select one of the signals as the receiver output.

Referring to FIG. 2, a terrestrial based radio communication system 200 is shown in accordance with present invention. The system 200 preferably comprises a transmission station 202 that transmits signals similar to the repeater stations described above or alternatively could be other transmission formats such as FM, or other modulation techniques suitable for transmission of digital audio. The system 200 also preferably includes a plurality of receiver units each preferably having a receiver 203, a means for retrieving environmental inputs such as a telematics information processor 214 that may ideally retrieve information such as mileage (via an odometer), speed, temperature, tire pressure, coolant levels, air bag deployment status, ABS break status, engine status, a vehicle status, a vehicle emergency system status, a vehicle user alert, and other inputs that can be obtained from a vehicle 28 such as an automobile, truck or boat. The system further preferably comprises a controller 212, a user input 216 (such as a keypad or alternatively, a monitor of user actions), and a radio frequency to audio (or to data) converter 206 for playing audio via speaker 208 or displaying data via a display 209 (or alternatively audibly outputting the data).

Referring to FIG. 3, a plurality of communication resource channels (Channel 1 through n) are shown in accordance with the present invention. In this instance, the over-the-air protocol frame format 300 of the XM Satellite Radio system is shown. This frame format 300 is based on a 432 millisecond frame as shown in FIG. 3 where each frame is subdivided into 8 kilobit per second sub-channels 102. These sub-channels 102 can be dynamically grouped to form higher bit rate payload channels 104. The payload channel or communication resource 104 provides the necessary bandwidth to transport a high-quality digital audio signal to the listener as well as other data as will become more apparent. When a listener changes channels, a receiver in accordance with the present invention simply extracts a different payload channel from the frame 300. It should be noted that each receiver in the XM Satellite System has a unique identifier allowing for the capability of individually addressing each receiver over-the-air to enable or disable services or to provide custom applications such as individual data services or group data services in accordance with the present invention.

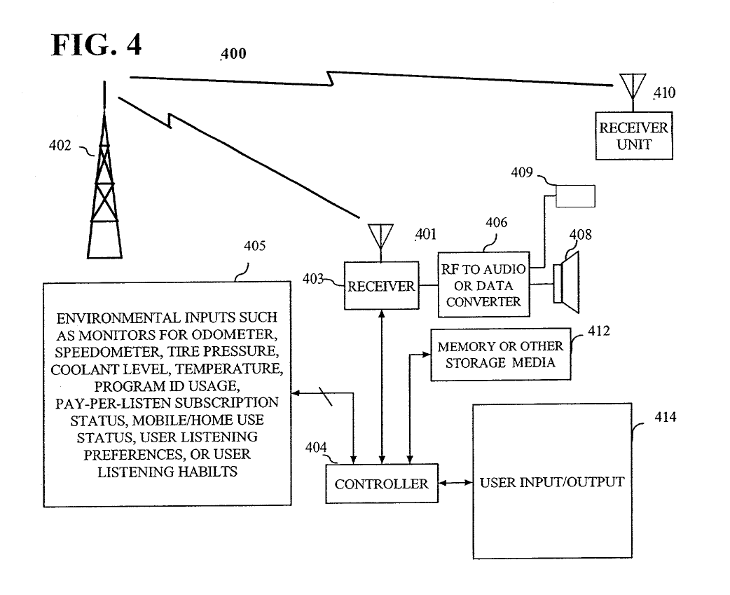

Referring to FIG. 4, a block diagram illustrating a digital audio radio system 400 in accordance with the present invention is shown. As with the system 200 of FIG. 2, the system 200 preferably comprises a transmission station 402 that transmits signals similar to the repeater stations described above or alternatively could be other transmission formats such as FM, or other modulation techniques suitable for transmission of digital audio. The system 400 also preferably includes a plurality of receiver units (401 and 410) each preferably having a receiver 403, a means 405 for retrieving environmental inputs such as a telematics information that may retrieve information such as mileage (via an odometer), speed, temperature, tire pressure, coolant levels, air bag deployment status, and other inputs that can be obtained from a given environment. The system further preferably comprises a controller 404, a user input 414 (such as a keypad or alternatively, a monitor of user actions), and a radio frequency to audio (or to data) converter 406 for playing audio via speaker 408 or displaying data via a display 409 (or alternatively audibly outputting the data).

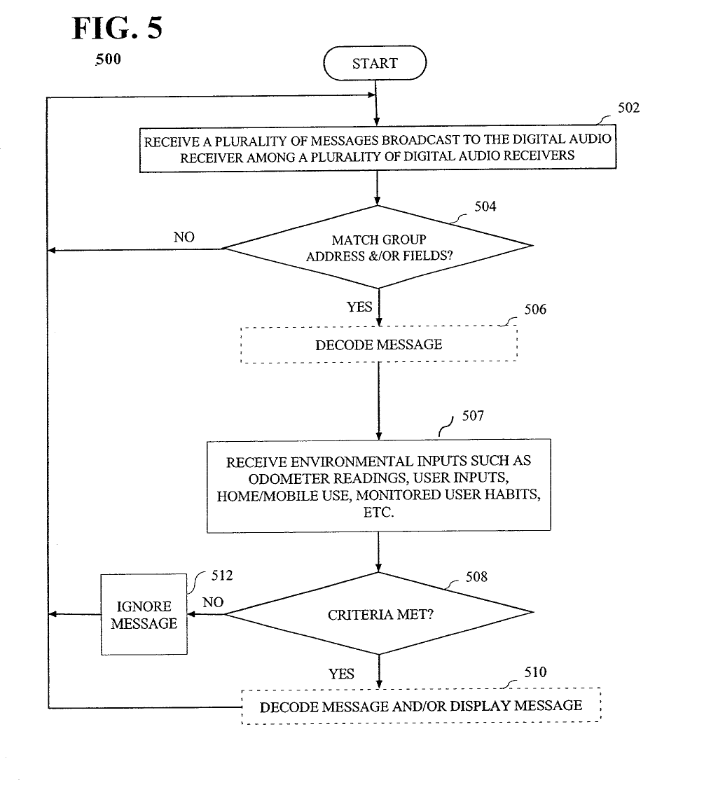

Referring to FIG. 5, a flow chart illustrating a method 500 in accordance with the present invention is shown. At step 502, at least one message such as a group message is broadcast to a digital receiver such as a digital audio receiver among a plurality of digital receivers. Preferably, the group message contains a group address that further provides an indication of a criteria or an environmental input. The group address itself or a field appended to the group address could contain the indication. For example, if a field or group address contains an indicia for a particular association with a vehicle such as make, model, mileage or otherwise, then the group address of field may possibly match at decision block 504. In one alternative embodiment, if such match exists, the message could be decoded at step 506 or the method would normally move on to monitor at step 507 the environmental inputs such as the odometer to determine if the values from the environmental inputs match or fall within a range meeting criteria in the group address or field. If the criteria are not met at decision block 508, then the message is ignored at block 512. If the criteria are met at decision block 508, then the message in another alternative embodiment at step 510 could be decode and/or displayed at this juncture rather than before the step of monitoring (507).

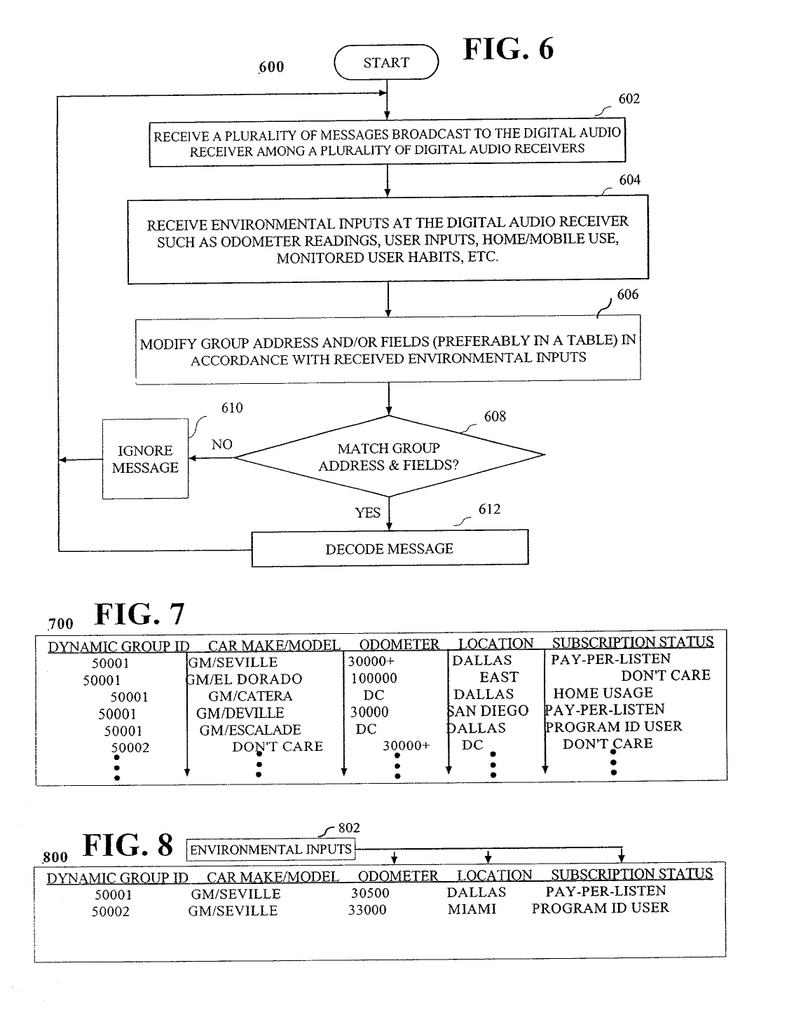

Referring to FIG. 6, a flow chart illustrating another method 600 in accordance with the present invention is shown. At step 602, at least one message such as a group message is broadcast to a digital receiver such as a digital audio receiver among a plurality of digital receivers. Preferably, the group message contains a group address that further provides an indication of a criteria or an environmental input. The group address itself or a field appended to the group address could contain the indication as previously explained. At step 604, inputs such as environmental inputs are received at the digital receiver and at step 606 group addresses and or fields that are already stored in the digital receiver could be modified in accordance with the received environmental inputs. Preferably, as shown in FIGS. 8 and 10, the group addresses or addresses and/or fields are maintained in a group address table. If the group address (and fields, if applicable) match or match and meet the criteria derived from the environmental inputs, then the message is decoded at step 612 or it is otherwise ignored at step 610 in the event of no match or failing to meet the criteria. As an example, if a General Motors car dealership wishes to target customers likely needing maintenance, a targeted message could be broadcast to such car owners having mileage in excess 30,000 miles. In such instance, a field or group address would contain an indicia for GM vehicles with more than 30,000 miles as shown in the 1st and 6th lines of the table 700 of FIG. 7. FIG. 7 represents a table of group addresses that could be transmitted over the air to the plurality of digital receivers. It should be noted that “DC” in this table indicates a “DON'T CARE” condition. FIG. 8 represents a table 800 of group addresses that could be stored and subsequently modified in accordance with environmental inputs 802 as shown. Thus, a digital receiver containing a stored group address table 800 would decode the first and sixth messages transmitted using group addresses in table 700 since the group id match and the corresponding fields all meet the criteria of one or more of the group addresses stored in table 700.

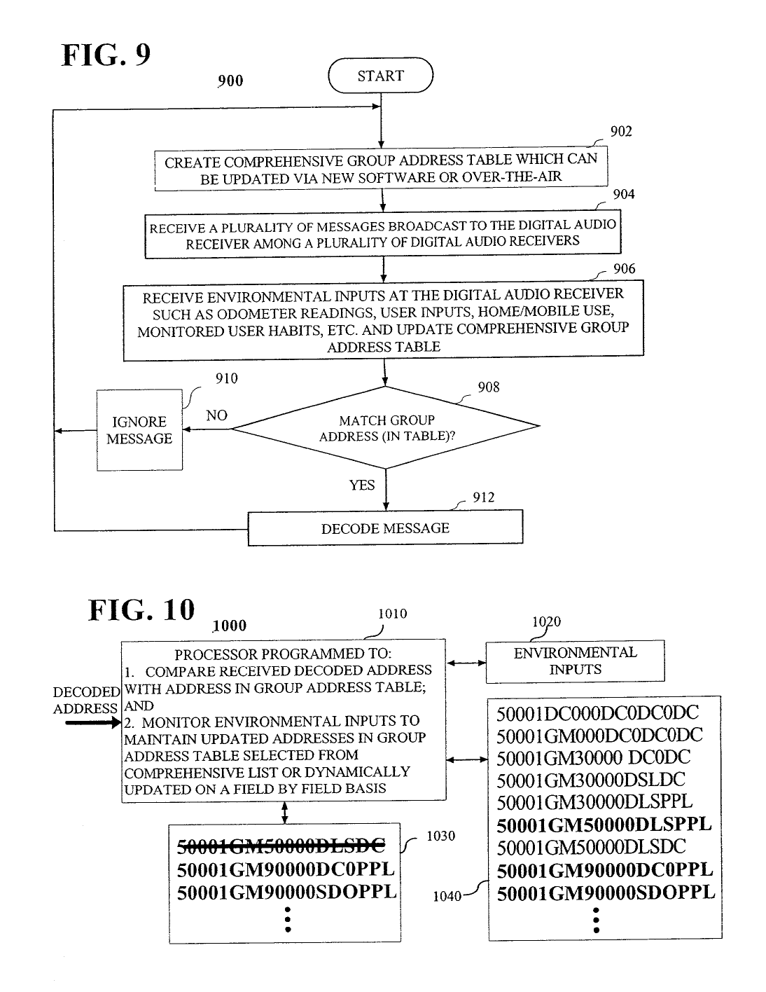

Referring to FIG. 9, a flow chart illustrating another method 900 in accordance with the present invention is shown. At step 902, a plurality of group addresses is stored in a digital receiver. Preferably, the plurality of group addresses is stored in a comprehensive group address table, which can be updated as needed over-the-air, or as a software download to a memory such as flash memory. As in the previously discussed methods above, at least one message such as a group message is transmitted and then received at step 904 by a digital receiver such as a digital audio receiver among a plurality of digital receivers. Preferably, the group message contains a group address that is associated with a criteria or an environmental input. Either the group address itself or a field appended to the group address could contain the indication as previously explained. Alternatively, the group address could include codes that could be decoded via a lookup table and further compared to group addresses stored in the digital receiver. At step 906, inputs such as environmental inputs are received at the digital receiver that can then be used to update a current group address table as will be further explained with respect to FIG. 10. If the group address matches at decision block 908, then the message is decoded at step 912. Otherwise, the message is ignored at step 910.

Referring to FIG. 10, a portion 1000 of a digital receiver unit is shown including a processor 1010, environmental inputs 1020, a comprehensive group address table 1040 and a current address table. As shown, the processor can be programmed to compare the received decoded address with an address in the current group address table. The processor also monitors environmental inputs to maintain updated addresses in the current group address table 1030 from the comprehensive group address table 1040. If the system is able to parse the address into fields, the processor may alternatively dynamically update the current addresses on a field by field basis based on the environmental inputs received. In the example shown, the addresses 50001GM50000DLSDC, 50001GM90000DCOPPL, and 50001GM90000SDOPPL are selected from the comprehensive group address table and placed or copied onto the current group address table. These addresses could reflect respectively, a General Motors automobile with 50,000 miles (or more) in Dallas, a General Motors automobile with 90,000 miles (or more) that has an owner subscribing to a pay-per-listen option, and a General Motors automobile with 90,000 miles (or more) in San Diego that has an owner subscribing to a pay-per-listen option. As the processor monitors the environmental inputs and sees that the car far exceeds 50,000 miles, the processor (if appropriately programmed) can remove the address 50001GM50000DLSDC which may not be pertinent to the existing customer.

The generality or granularity reflected in this example is not intended to limit the scope of the invention. The description above is intended by way of example only and is not intended to limit the present invention in any way except as set forth in the following claims.

We claim:

1. A method of dynamic group addressing in a digital audio receiver unit, comprising the steps of:
receiving a plurality of messages broadcast to a digital audio receiver among a plurality of digital audio receivers;
receiving at least one environmental input at the digital audio receiver; and
selectively decoding at least one of the plurality of messages broadcast based on a selective call address and said at least one environmental input received at the digital audio receiver.

2. The method of claim 1, wherein the step of selectively decoding comprises the step of modifying a group address stored in the digital audio radio based on said at least one environmental input received to create a modified group address and comparing the modified group address with a received group address associated with one of the plurality of messages.

3. The method of claim 1, wherein the step of selectively decoding comprises the step of comparing a group address stored in the digital audio radio with a received group address associated with one of the plurality of messages and further comparing a field appended to the received group address with a value corresponding to the at least one environmental input.

4. The method of claim 1, wherein the step of selectively decoding comprises the step of comparing a received group address from one of the plurality of messages with an address in a current group address table that is updated with group addresses from a comprehensive group address table based on the environmental inputs received at the digital audio receiver.

5. The method of claim 1, wherein the step of receiving said at least one environmental input comprises the step of receiving at least one among vehicle heath conditions selected from the group comprising an odometer reading, a speed reading, a temperature reading, a tire pressure reading, a coolant level reading, an air bag deployment status, an ABS break status, or an engine status.

6. The method of claim 1, wherein the step of receiving at least one environmental input comprises the step of receiving user inputs.

7. The method of claim 6, wherein the step of receiving environmental input further comprises the step of determining if a user is using a program identification function on the digital audio receiver.

8. The method of claim 6, wherein the step of receiving environmental input further comprises the step of determining if a user subscribes to a pay-per-listen subscription.

9. The method of claim 1, wherein the step of receiving environmental inputs further comprises the step of determining a user's listening habits.

10. A digital receiver unit having dynamic group addressing, comprising:
a digital audio receiver for receiving a plurality of messages that can be targeted;
a plurality of environmental inputs used for targeting at least one of the plurality of messages; and
a processor programmed to:
(a) receive at least one of the plurality of environmental inputs;
(b) dynamically address the plurality of messages based on the data obtained from the at least one of the plurality of environmental inputs.

11. The digital receiver unit of claim 10, wherein the at least one environmental input is selected among one or more of the group comprising an odometer reading, vehicle status, vehicle emergency system status, vehicle user alert, a program ID status, a pay-per-listen subscription status, a fuel level, a speed reading, a temperature reading, a tire pressure reading, a coolant level, an airbag deployment status, a location, a mobile/home use status or a listening preference based on actual listening habits of a user.

12. The digital receiver unit of claim 10, wherein the digital receiver unit is a satellite digital audio radio.

13. A digital receiver unit that can be dynamically addressed, comprising:
a receiver capable of receiving a plurality of content specific messages; and
a processor for receiving at least one environmental input used to dynamically address the receiver, wherein the processor is programmed to selectively decode messages matching a condition set by the at least one input.

14. The digital receiver unit of claim 13, wherein the processor selectively decodes by modifying a group address stored in the digital receiver unit based on the at least one environmental input received to create a modified group address and wherein the processor further compares the modified group address with a received group address associated with one of the plurality of content specific messages.

15. The digital receiver unit of claim 13, wherein the processor compares a group address stored in the digital receiver unit with a received group address associated with one of the plurality of content specific messages and further compares a field appended to the received group address with a value corresponding to the at least one environmental input.

16. The digital receiver unit of claim 13, wherein the processor compares a received group address from one of the plurality of content specific messages with an address in a current group address table that is updated with group addresses from a comprehensive group address table based on the environmental inputs received at the digital receiver unit.

17. The digital receiver unit of claim 13, wherein the at least one environmental input is selected among one or more of the group comprising an odometer reading, a fuel level, a speed reading, a temperature reading, a tire pressure reading, a coolant level, an airbag deployment status, a vehicle status, a vehicle emergency system status, a vehicle user alert, a location, a mobile/home use status, a program ID status, a pay-per-listen subscription status, or listening preferences based on actual listening habits of a user.

18. A satellite digital radio capable of being addressed with selective call messages, comprising:
a selective call receiver for receiving a plurality of messages targeted for a group of users meeting a specified criteria;
a plurality of inputs coupled to a user interface for the satellite digital radio for providing at least a portion of the specified criteria; and
a decoder coupled to the selective call receiver for decoding at least a portion of the plurality of messages matching a dynamic group call address created with and meeting the specified criteria.

19. The satellite digital radio of claim 15, wherein the specified criteria is extracted from at least one or more inputs selected among the group of an odometer reading, a speed reading, a temperature reading, tire pressure reading, a coolant level, fuel level, an airbag deployment status, a vehicle status, a vehicle emergency system status, a vehicle user alert, a location, a program ID status, a pay-per-listen subscription status, a mobile/home use status or a listening preference based on actual listening habits of a user.

20. The satellite digital radio of claim 16, wherein the satellite digital radio is integrated in a telematics system in an automobile.
